(19) United States
(12) Patent Application Publication
(10) Pub. No.: US 2019/0239659 A1
(43) Pub. Date: Aug. 8, 2019

(54) MANNEQUIN ATTACHMENT DEVICE FOR HOODED GARMENT SUPPORT

(71) Applicant: NOA Brands America, Inc., Lafayette, CO (US)

(72) Inventors: Ashley Benbow, Erie, CO (US); Stacie Bornn, Erie, CO (US)

(73) Assignee: NOA Brands America, Inc., Lafayette, CO (US)

(21) Appl. No.: 16/268,672

(22) Filed: Feb. 6, 2019

Related U.S. Application Data
(60) Provisional application No. 62/626,783, filed on Feb. 6, 2018.

(51) Int. Cl. A47F 8/02; B33Y 50/00; B33Y 80/00

(52) U.S. Cl. CPC A47F 8/02; B33Y 10/00; B33Y 80/00; B33Y 50/00

(57) ABSTRACT

Mannequin attachment devices are disclosed that are designed to be operationally connectable to a mannequin for supporting, stabilizing, and giving shape to headwear or a hood of a garment worn by the mannequin. Exemplary mannequin attachment devices include a lower portion operative to hold the device in a substantially fixed position upon an associated mannequin; a substantially hemispherical upper portion; and an intermediate portion extending between and interconnecting the lower portion to the upper portion. Systems are also disclosed that include such a mannequin attachment device and a mannequin having at least a neck structure and a shoulder structure. Methods of manufacturing such a mannequin attachment device are also disclosed, which methods include providing a mannequin, obtaining data regarding the mannequin, designing a mannequin attachment device shaped complementary to the mannequin, and producing the mannequin attachment device.

### CROSS-REFERENCE TO RELATED APPLICATION(S)

This application claims priority to U.S. Provisional Patent Application No. 62/626,783, filed Feb. 6, 2018, the contents of which are hereby incorporated by reference in their entireties.

### TECHNICAL FIELD

The present disclosure relates to mannequins. More specifically, aspects of the present disclosure may relate to mannequin attachment devices, systems including mannequin attachment devices, methods for manufacturing mannequin attachment devices, and/or methods of using mannequin attachment devices.

### BACKGROUND

Mannequins may be used to showcase or otherwise display articles, such as items of clothing or accessories, to be worn on a person to demonstrate how the articles might look on a person. Mannequins come in many shapes and sizes and may constitute a full-size human body (including, for example, all limbs and a head), or alternatively a subset of a human body (e.g., a body part such as a torso or even just a finger). Mannequins may be able to be assembled or disassembled through one or more mechanical attachment means. Retailers may have varying needs for mannequins. For example, in one season, a retailer may need only a torso to display a shirt, but in another season, a retailer may want to display a hooded sweatshirt in combination with jeans, so a head and legs may be beneficial. Reconfiguring mannequins, however, may present challenges, as the attachment mechanisms holding a full-size mannequin together may be complex or difficult to quickly disengage. Furthermore, retailers may have a surplus of mannequins in a particular configuration (e.g., a headless torso with arms) but may wish to repurpose one or more of the mannequins in a particular season (e.g., with a head to display headwear in fall or winter).

There may be a commercial need for a mannequin attachment device that can be easily added to or removed from a mannequin, such as for the display of hooded garments or headwear. There may also be a commercial need for systems including a mannequin and a custom-fit mannequin attachment device that is not mechanically attached to the mannequin, such that it can be easily added thereto when it is desirable to display the mannequin with headwear or a hooded garment. There is also a need for efficient manufacturing procedures for mannequin attachment devices, including mannequin attachment devices that are customized to the specific contoured shape of an existing mannequin.

A number of mannequin attachment devices exist, such as the traditional “hat dome” design, which requires mechanical attachment to a mannequin, often with a metal rod inserted into the mannequin's spine. Other mechanical attachment mechanisms may be used, as will be familiar to a person of ordinary skill in the art. These existing attachment mechanisms may require an undesirable amount of time and effort or may require specialized knowledge to properly manipulate, attach, or remove the attachment mechanisms. Existing mannequin attachment devices have been unsatisfactory for the purpose of quickly and easily adding or removing the attachment device as desired. Existing mannequin attachment devices may be highly susceptible to damaging the mannequin if improperly installed or if the mannequin falls while the attachment device is still attached thereto. Further, existing mannequin attachment devices may not be customizable for use with mannequins of any shape or size and may not include customized features that, for example, contour to the undulations of a particular mannequin.

Accordingly, there is a need for one or more mannequin attachment device(s) that may solve or mitigate one or more of the aforementioned issues.

### BRIEF SUMMARY

The present disclosure relates, in various embodiments, to a mannequin attachment device and to systems including the mannequin attachment device and methods of manufacturing the mannequin attachment device. The mannequin attachment device may be designed to be operatively connectable to a mannequin for stabilizing and giving shape to an item of apparel worn by the mannequin. In an embodiment, a mannequin attachment device may be configured as headwear or the hood of a garment.

Exemplary embodiments disclosed herein include mannequin attachment devices that may include: a lower portion operative to hold the device in a substantially fixed position upon an associated mannequin, the lower portion including first and second side segments extending outwardly in opposing directions from a central segment thereof; a substantially hemispherical upper portion; and an intermediate portion extending between and interconnecting the lower portion to the upper portion.

In an embodiment, the lower portion can be shaped so as to at least partially simulate the shoulder structure of the human anatomy. In an embodiment, the upper portion can be shaped so as to at least partially simulate the cranial structure of the human anatomy. In an embodiment, the intermediate portion can be shaped so as to at least partially simulate the neck structure of the human anatomy.

In certain exemplary embodiments, the first and second side segments can each be bowed from a front edge to a rear edge thereof.

The upper portion can be substantially centered between the first and second side segments and above the central segment. The upper portion can have a concave inner surface and a convex outer surface.

In particular exemplary embodiments, the mannequin attachment device can be from a material selected from a group including cardboard, polyurethane, metal, plaster, plastic, recyclable paper, fiberglass, ceramic, and wood. Additionally or alternatively, a mechanical attachment device may be a composite made of two or more combinations of materials, or may be reinforced with materials such as carbon fiber, glass, and the like.

In some embodiments, a mannequin attachment device can have a substantially constant thickness of between about 0.05 and about 0.5 inches.

Additional exemplary embodiments disclosed herein may include: a mannequin having a shoulder structure and a neck structure protruding upwardly from the shoulder structure; and a mannequin attachment device including a lower portion operative to hold the device in a substantially fixed position upon the mannequin, the lower portion including first and second side segments extending outwardly in opposing directions from a central segment thereof; a substantially hemispherical upper portion; and an intermediate portion extending between and interconnecting the lower portion to the upper portion; and wherein the mannequin attachment device is operatively connected to the mannequin but is not mechanically attached to the mannequin.

In certain exemplary embodiments, the intermediate portion of the mannequin attachment device can be shaped complementary to the neck structure of the mannequin. An inner surface of the intermediate portion can be configured for selective abutment against the neck structure of the mannequin.

In certain exemplary embodiments, the lower portion of the mannequin attachment device can be shaped complementary to the shoulder structure of the mannequin. An inner surface of the lower portion can each be configured for selective abutment against the shoulder structure of the mannequin. In particular embodiments, the shoulder structure of the mannequin can include one or more undulations. The first and second side segments and the central segment can each be configured for selective abutment against the one or more undulations of the shoulder structure of the mannequin.

In an embodiment, the upper portion of the mannequin attachment device does not abut any part of the mannequin.

In an embodiment, the lower, intermediate, and upper portions of the mannequin attachment device can be integrally formed.

In particular exemplary embodiments, the system can further comprise an item of apparel selected from the group consisting of a garment having a hood and headwear. The upper portion of the device can be operative to stabilize and give shape to the item of apparel.

Still further embodiments disclosed herein may include methods of manufacturing a mannequin attachment device, the methods comprising: providing a mannequin having a shoulder structure and a neck structure protruding upwardly from the shoulder structure; obtaining data regarding the mannequin's shoulder structure and neck structure; designing a mannequin attachment device including: a lower portion shaped complementary to the mannequin's shoulder structure and operative to hold the device in a substantially fixed position upon the mannequin, the lower portion including first and second side segments extending outwardly in opposing directions from a central segment thereof; a substantially hemispherical upper portion; and an intermediate portion shaped complementary to the mannequin's neck structure, the intermediate portion extending between and interconnecting the lower portion to the upper portion; and manufacturing the mannequin attachment device.

In certain exemplary embodiments, the method can further comprise transferring the data to a computer-aided-design program. Additionally, the method can further comprise creating a virtual image of the mannequin using the obtained data prior to designing the mannequin attachment device.

The mannequin attachment device can be produced, for example, by a process selected from a group including three-dimensional printing, blow molding, injection molding, rotational molding, and casting.

Disclosed in other exemplary embodiments herein may be methods of manufacturing a mannequin attachment device, the methods comprising: obtaining data from a topographical scan of a mannequin; creating a virtual image of a mannequin attachment device; successively distributing a selected number of substantially even layers of a material over a confined region defined by the virtual image of the mannequin attachment device; and binding the material in each successive layer with a laser until the mannequin attachment is fully constructed.

The material can, in certain exemplary embodiments, be a polymeric material, a powder material, a resin material, a filament material, or combinations thereof.

Obtaining data from the topographical scan of the mannequin can include obtaining three-dimensional reference points of the outer surface of the mannequin. The methods may further comprise a virtual image of the outer surface of the mannequin using the obtained three-dimensional reference points.

In certain embodiments, creating the virtual image of the mannequin attachment device can include plotting three-dimensional definition points corresponding to an inner surface of the mannequin attachment device. The definition points of the inner surface of the mannequin attachment device may be spaced outwardly apart a selected distance from corresponding ones of the reference points of the outer surface of the mannequin. In this way, the mannequin attachment device may be operatively connectable to fit snugly and exactly upon the mannequin.

### BRIEF DESCRIPTION OF THE DRAWINGS

The foregoing and other features of the present disclosure will become more fully apparent from the following description and appended claims, taken in conjunction with the accompanying drawings. Understanding that these drawings depict several examples in accordance with the disclosure and are, therefore, not to be considered limiting of its scope, the disclosure is described with additional specificity and detail below through the use of the accompanying drawings.

FIG. 1 is a front view of an exemplary system according to an embodiment of the present disclosure including a mannequin attachment device operatively connected to a mannequin.

FIG. 2 is a first side view of an exemplary system according to an embodiment of the present disclosure.

FIG. 3 is a rear view of an exemplary system according to an embodiment of the present disclosure.

FIG. 4 is a second side view of an exemplary system according to an embodiment of the present disclosure.

FIG. 5 is a bottom view of a mannequin attachment device used in an exemplary system according to an embodiment of the present disclosure.

FIG. 6 is a front view of an exemplary system in use with a garment having a hood according to an embodiment of the present disclosure.

FIG. 7 is a perspective view of an exemplary system in use with a garment having a hood according to an embodiment of the present disclosure.

FIG. 8 illustrates a method manufacturing a mannequin attachment device according to an embodiment of the present disclosure.

FIGS. 9A-9D are views of an exemplary system according to an embodiment of the present disclosure including a mannequin attachment device operatively connected to a mannequin, where FIG. 9A is a rear view, FIG. 9B is a first side view, FIG. 9C is a front view, and FIG. 9D is a second side view.

FIGS. 10A-10H are views of an exemplary system according to an embodiment of the present disclosure including a mannequin attachment device operatively connected to a mannequin, where FIG. 10A is a front view, FIG. 10B is a first side front perspective view, FIG. 10C is a first side view, FIG. 10D is a first side rear perspective view, FIG. 10E is a rear view, FIG. 10F is a second side rear perspective view, FIG. 10G is a second side view, and FIG. 10H is a second side front perspective view.

FIGS. 11A-11H are views of an exemplary system in use with a garment having a hood according to an embodiment of the present disclosure, where FIG. 11A is a front view, FIG. 11B is a first side front perspective view, FIG. 11C is a first side view, FIG. 11D is a first side rear perspective view, FIG. 11E is a rear view, FIG. 11F is a second side rear perspective view, FIG. 11G is a second side view, and FIG. 11H is a second side front perspective view.

### DETAILED DESCRIPTION

In the following detailed description, reference is made to the accompanying drawings, which form a part hereof. In the drawings, similar symbols identify similar components, unless context dictates otherwise. The illustrative examples described in the detailed description and drawings are not meant to be limiting and are for explanatory purposes. Other examples may be utilized, and other changes may be made, without departing from the spirit or scope of the subject matter presented herein. It will be readily understood that the aspects of the present disclosure, as generally described herein and illustrated in the drawings, may be arranged, substituted, combined, and designed in a wide variety of different configurations, each of which are explicitly contemplated and make part of this disclosure.

A mannequin attachment device may be described in various embodiments herein that may be designed to be operatively connectable to a mannequin for stabilizing and giving shape to an article of clothing. In an embodiment, the article of clothing may be headwear or a hood of a garment worn by the mannequin. Mannequin attachment devices described herein may be capable of being operatively connected to or placed in engagement with a mannequin, such as by being shaped complementarily to the underlying mannequin. In an embodiment, a mannequin attachment device may remain in a substantially snug engagement with a mannequin without the use of a mechanical engagement device. In particular, a mannequin attachment device may be positioned onto a mannequin and may stay engaged therewith through abutment with the mannequin's undulations. For example, a mannequin attachment device may be designed to have complementary contours to the contours of a mannequin. In an embodiment, friction from the abutment of the mannequin attachment device to the mannequin, gravitational forces, and/or force created by the weight or constriction (or, generally, the presence) of clothing affixed to the mannequin attachment device and mannequin may prevent the mannequin attachment device from shifting on the mannequin during use without the need for any mechanical attachment between the mannequin and the mannequin attachment device. By not requiring mechanical attachment to a mannequin, mannequin attachment device(s) of the present disclosure can be quickly and easily added to or removed from a mannequin and, in an embodiment, can advantageously be customized to be operatively connected to mannequins of any size or shape.

In use, a mannequin attachment device may be substantially non-visible (i.e., visibility of the devices may be substantially minimized when in use with a mannequin wearing a hooded garment). In an embodiment, a mannequin attachment device may include a portion of the device that approximates the shape of at least a portion of a mannequin, such as an upper torso portion of a mannequin (including, e.g., shoulders, upper back, and/or upper chest portions). Alternatively, a mannequin attachment device may have a customized shape based on the design of a mannequin or type of mannequin. For example, a mannequin attachment device may be customized for male, torso-only mannequins; female torso-and-leg mannequins; and other combinations of mannequin features as will be apparent to one of ordinary skill in the art. In such a case, a mannequin attachment device may approximate the size and shape of a particular mannequin based on certain mannequin characteristics (e.g., sex, size, age, body type, etc.). In another alternative embodiment, a mannequin attachment device may be fully customized (or customizable) based on the particular features of a particular mannequin. For example, a three-dimensional, computer-generated model of the particular size and shape of a mannequin may be generated and used as a basis to fabricate a mannequin attachment device fully customized to the particular mannequin, e.g., through additive manufacturing or 3D printing. Based upon a customized design of a mannequin attachment device, users can display, for example, hooded garments or other headwear without the need for a mannequin having a specific head shape or size. In this way, mannequin attachment devices of the present disclosure can be designed for a custom fit to an existing mannequin. This may ensure a snug and/or exact cooperative engagement with a mannequin such that a mannequin attachment device maintains a substantially constant position relative to a mannequin in a typical mannequin setting (e.g., displaying clothes in a retail store) without a mechanical attachment mechanism. Mannequin attachment devices of the present disclosure can be quickly and easily added to or removed from a mannequin without the need for any special tools or hardware, without the risk of damaging the associated mannequin, and without the need for modifying the mannequin in any way, thereby giving users complete and customized visual display control.

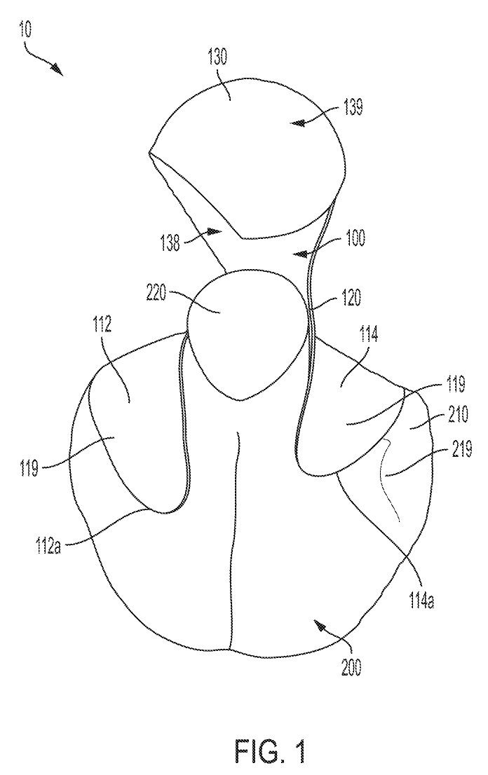

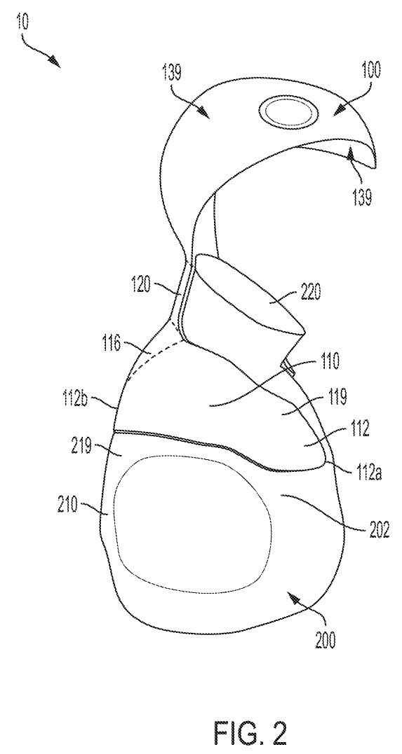

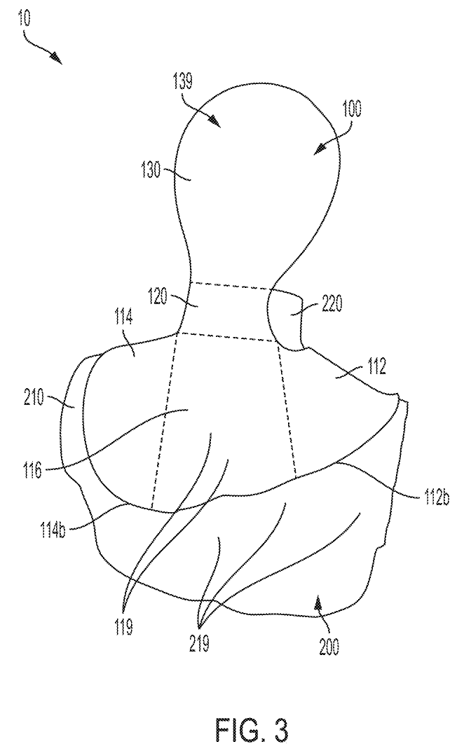

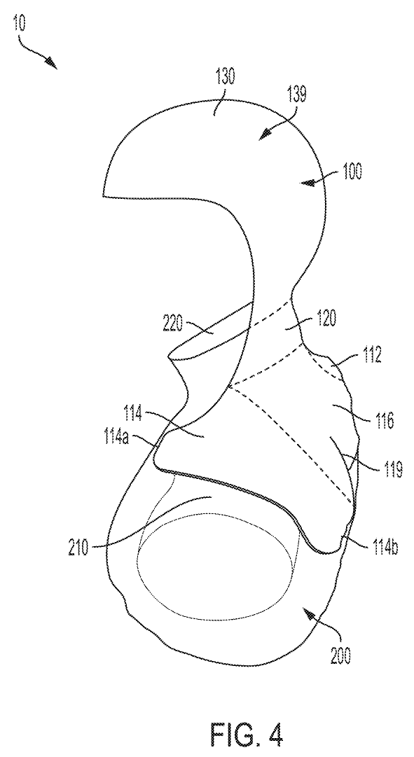

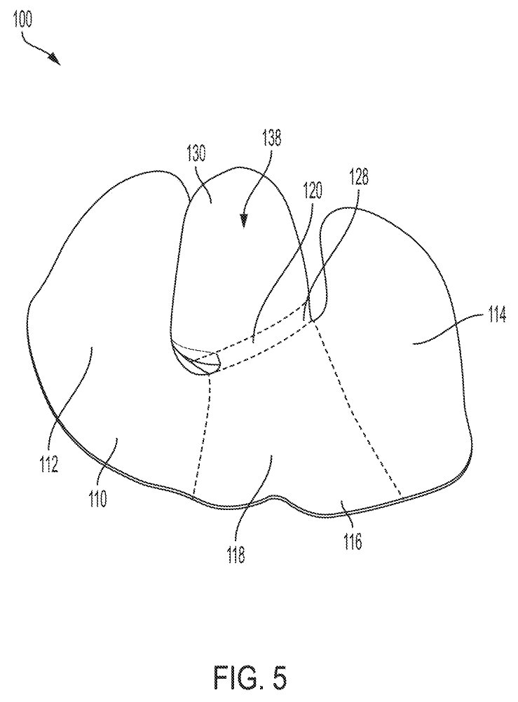

FIG. 1 shows a front view of an exemplary mannequin attachment device and mannequin system 10 according to an embodiment of the present disclosure. System 10 may be used, for example, to display a hooded garment or other headwear on a mannequin, particularly a headless mannequin. The system 10 may include a mannequin attachment device 100 operatively connected to a mannequin 200. In this embodiment, the example mannequin attachment device 100 is configured to support a hood or headwear. FIG. 2 shows a first side view of system 10, FIG. 3 shows a rear view of system 10, and FIG. 4 shows a second side view of system 10. FIG. 5 is a bottom view of a mannequin attachment device 100 that may be used in system 10 showing the inner surfaces of the various parts of this embodiment of the mannequin attachment device 100. As can be seen in FIGS. 1-5, in an embodiment, a mannequin attachment device 100 may be formed as a unitary piece. A mannequin attachment device 100 formed as a unitary piece may, for example, be manufactured using an additive manufacturing or 3D printing process.

The mannequin 200 is depicted in these figures as a partial mannequin. In other words, the mannequin 200 is depicted in these figures with only certain portions of an upper torso. It is to be understood, however, that mannequins of any size or shape can be used, and the mannequins can be complete mannequins or partial mannequins (i.e., lacking a head or other body parts, such as appendages or limbs). The mannequin 200 of this exemplary embodiment is a partial mannequin including a shoulder structure 210 and a neck structure 220.

The neck structure 220 may be substantially cylindrical and may be shaped to at least partially simulate the neck of the human anatomy. In comparison, the shoulder structure 210 is shaped so as to at least partially simulate, or sit co-extensive with, the shoulders of the human anatomy as depicted on a mannequin, including certain undulations and other features as will be described herein. In embodiments such as that depicted in FIGS. 1-4, the shoulder structure 200 of the mannequin 200 can include undulations 219 or other features that simulate the contours of the shoulders and upper back of the human anatomy.

As shown in FIGS. 1-4, the shoulder structure 210 and the neck structure 220 may be integrally formed, with the neck structure 220 protruding upwardly from the shoulder structure 210. In an embodiment, the shoulder structure 210 and the neck structure 220 may be integrally formed from a 3D printing or additive manufacturing process. In embodiments, the mannequin 200 may be a headless mannequin with no means, in itself, for supporting, stabilizing, or giving shape to a hooded garment or other headwear. As will be appreciated by one of ordinary skill in the art, often retailers and other mannequin users may own significant numbers of mannequins, and some of these mannequins may not have any mechanism (such as an integral or mechanically attachable head) by which to support a hat, hood, or other headwear.

In use, the mannequin can be fitted with garments or other products to be displayed by a user. In particular, the mannequin 200 of this exemplary embodiment can include a garment having a hood (not depicted). With a headless mannequin such as that depicted herein, without a mannequin attachment device, the lower portion of the garment would typically be supported by the shoulder structure 210 of the mannequin to give the garment shape. The hood of the garment, however, would not be supported and would simply drape over the neck portion 220 of the mannequin 200. Such a result is undesirable because someone viewing the mannequin would have the disadvantage of not being visually presented with a representation of how the hood of the garment would look on a real human body.

In part to solve disadvantages such as this, the system 10 may be further provided with a mannequin attachment device 100. Mannequin attachment device 100 may be designed to support, stabilize, and/or give shape to the hood of the garment or other headwear to be used with the mannequin 200. A mannequin attachment device 100 of this exemplary embodiment may include a lower portion 110, an intermediate portion 120, and an upper portion 130. In an embodiment, the lower portion 110, intermediate portion 120, and upper portion 130 of a mannequin attachment device 100 may be integrally formed.

The lower portion 110 of a mannequin attachment device 100 may be operative to hold (or, alternatively, to contribute to holding) the device in a substantially fixed position upon an associated mannequin. For example, as shown in FIGS. 1-4, the lower portion 110 may be configured to engage with the shoulder structure 210 of mannequin 200. In embodiments, the lower portion 110 may be shaped partially or wholly simulate the shoulder structure (which may include, e.g., shoulder blades) of the human anatomy.

The lower portion 110 may be preferably shaped complementary to the shoulder structure 210 of the mannequin 200. In this way, an inner surface 118 of the lower portion 110 of a mannequin attachment device 100 (refer to FIG. 5) may be configured for complementary abutment against the shoulder structure 210 of the mannequin. More specifically, the lower portion 110 of a mannequin attachment device 100 may be designed to operatively connect in a snug or, in some embodiments, an exact, engagement with the shoulder structure 210 of the mannequin. This complementary abutment ensures both that (a) a mannequin attachment device 100 may be fixed on the mannequin 200 and will not become operatively disconnected by accident during normal use such as for the passive display of retail clothing, and (b) the combination of a mannequin attachment device 100 and the mannequin 200 may give the system 10 the appearance (or approximate appearance) of the human anatomy, thereby presenting someone viewing the system with a visually appealing representation of how a hooded garment or other headwear may look on a real human body.

As can be seen in FIGS. 1-4, the lower portion 110 of a mannequin attachment device 100 can include undulations 119 or other features that may be shaped complementary to any undulations or features of the shoulder structure of the mannequin with which the device may be used. For example, as depicted in FIGS. 1-4, the lower portion 110 may be configured for selective abutment against the undulations 219 of the shoulder structure 210 of the mannequin 200. This may ensure that a mannequin attachment device 100 contours to the shape of the mannequin 200 and may provide for a snug operative connection thereto without the need for any mechanical attachment. Again, this snug operative connection may give the system 10 an appearance that is both visually appealing and accurately reflects the contours and curves of the human anatomy.

As can be seen in FIG. 3, the lower portion 110 (labeled in FIGS. 2 and 4; label omitted from FIG. 3 for clarity) of a mannequin attachment device 100 may include a first segment 112, a second segment 114, and a central segment 116. The first and second side segments 112, 114 extend outwardly from the central segment 116 in opposing directions. As can be seen in FIG. 2, the first side segment 112 may be bowed from its front edge 112a to its rear edge 112b. As can be seen in FIG. 4, the second side segment 114 may be bowed from its front edge 114a to its rear edge 114b. In this way, the bowed first and second side segments 112, 114 interconnected by the central segment 116 may form a bowed hippocrepiform.

In this exemplary embodiment, the bowed shape of the lower portion 110 may complement the arced shape of the shoulder structure 210 of the mannequin 200, such that the lower portion may hold, at least in part, a mannequin attachment device 100 in a substantially fixed position on the mannequin 200. In particular, the lower portion 110 may provide rigid structural support and may help to ensure that a mannequin attachment device 100 does not tip forward or backward (due at least in part to the bowed first and second side segments 112, 114 snugly engaging the shoulder structure of the associated mannequin) and/or become operatively disconnected from the associated mannequin.

As depicted herein, the lower portion 110 may be constructed with the first side segment 112 and the second side segment 114 interconnected by the central segment 116, but without physically touching one another (i.e., there may be an empty space defined between the front edge 112a of the first side segment 112 and the front edge 114a of the second side segment 114). It is to be understood, however, that the lower portion 110 could alternatively be designed with the first and second side segments 112, 114 meeting at a front point spaced apart from the central segment 116, such that the lower portion 110 may be shaped like a donut with a hollow interior defined between the first side segment 112, the second side segment 114, and the central segment 116.

The upper portion 130 of a mannequin attachment device 100 may be operative to support, stabilize, and provide shape to a hooded garment or other headwear desired to be displayed on a mannequin attachment device 100.

In an embodiment, such as the exemplary embodiment depicted in FIGS. 1-5, the upper portion 130 may be substantially hemispherical. More particularly, in an embodiment, the upper portion 130 may be shaped much like a cobra head, such that the upper portion has a substantially hemispherical profile defined by a concave inner surface 138 and a convex outer surface 139. In this way, the upper portion 130 may be shaped to at least partially simulate the cranial structure of the human anatomy.

The outer surface 139 of the upper portion 130 may contact the inner surface of the hood of a garment or other headwear used with the mannequin and may provide structural support therein. In addition, the convex shape of the outer surface 139 of the upper portion 130 may stabilize and shape the hood or other headwear, such that the visual appearance of the headwear or hood may be substantially equivalent to its appearance when worn by a real human. In an embodiment, the upper portion 130 does not contact or abut the mannequin 200.

In embodiments, the upper portion 130 can be substantially centered above the central segment 116 of the lower portion 110 between the first and second side segments 112, 114 thereof, similar to the position of a human's head above the neck and substantially centered between the shoulders. In this way, the upper portion 130, the intermediate portion 120, and the lower portion 110 of a mannequin attachment device 100 together may accurately reflect the cranial, neck, and shoulder structures, respectively, of the human anatomy.

The intermediate portion 120 of a mannequin attachment device 100 may interconnect the lower portion 110 and the upper portion 130. As can be seen in FIG. 3, the intermediate portion 120 can be substantially centered below the upper portion 130 and above the central segment 116 of the lower portion 110 between the first and second side segments 112, 114 thereof. In particular, the intermediate portion 120 may extend upwardly from the central segment 116 of the lower portion 110 and may terminate at the upper portion 130. In this way, the intermediate portion 120 may be shaped so as to at least partially simulate the neck structure of the human anatomy.

The intermediate portion 120 may be preferably shaped complementary to the neck structure 220 of the mannequin 200. In this way, an inner surface 128 of the intermediate portion 120 of a mannequin attachment device 100 (refer to FIG. 5) may be configured for selective abutment against the neck structure 220 of the mannequin. The intermediate portion 120 may provide rigid structural support for the upper portion 130 and may help ensure that a mannequin attachment device 100 does not tip forward and become operatively disconnected from the associated mannequin. The intermediate portion 120 may be designed to support the upper portion 130 and any hood or other headwear supported thereon, including headwear of significant weight (e.g., a helmet). In an embodiment, clothing on a mannequin having a mannequin attachment device operatively associated therewith may provide additional support and may also help to maintain a snug connection between the mannequin and the mannequin attachment device (e.g., through the weight and/or constriction of the clothing).

In embodiments, the intermediate portion 120 can have a substantially planar profile or, alternatively, the intermediate portion 120 can have a substantially concave profile that may be complementary in shape to the cylindrical neck structure 220 of the mannequin 200.

In embodiments, the intermediate portion 120 of a mannequin attachment device 100 may be designed to be smaller than (or, alternatively, to have a width that is less than the width of) the neck structure 220 of the mannequin 200. Similarly, the upper portion 130 of a mannequin attachment device 100 can be designed to be smaller than hood or other headwear with which a mannequin attachment device may be used. Both of these parameters may help to ensure that a mannequin attachment device 100 is substantially non-visible or merely slightly visible behind the garment or other headwear, which may provide a visually pleasing experience for a user (e.g., a retailer and/or a consumer) when a mannequin attachment device is in use.

FIGS. 12A-12H show additional embodiments of a system with a mannequin attachment device fitted upon a mannequin.

To fit the mannequin 200 with a mannequin attachment device 100, a mannequin attachment device 100 can be lowered down upon the mannequin 200 in the following manner. First, the neck structure 220 of the mannequin 200 can be straddled from above by the first and second side segments 112, 114 of a mannequin attachment device 100. A mannequin attachment device 100 can then be lowered downwardly and brought to rest upon the mannequin 200 such that the inner surface 118 of the lower portion 110 of a mannequin attachment device 100 selectively abuts the contours, undulations, and/or other features of the shoulder structure 210 of the mannequin 200 (e.g., contours simulating muscles). Similarly, the inner surface 128 of the intermediate portion 120 of a mannequin attachment device 100 may selectively abut the neck structure 220 of the mannequin 200. As a result, the upper portion 130 of a mannequin attachment device 100 may be positioned substantially centrally above the neck structure 220 of the mannequin 200 and may be ready to receive the hood of a garment or other headwear desired to be displayed on the mannequin 200.

To dress the mannequin 200 with headwear, it is possible to fit the headwear to the upper portion 130 of a mannequin attachment device 100 either before or after fitting a mannequin attachment device 100 upon the mannequin 200. Additionally, in the case of headwear, a mannequin attachment device 100 can be used independently of the mannequin 200, if desired.

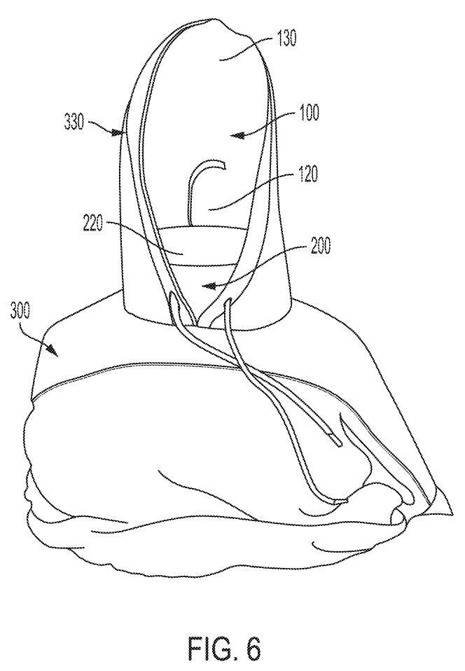

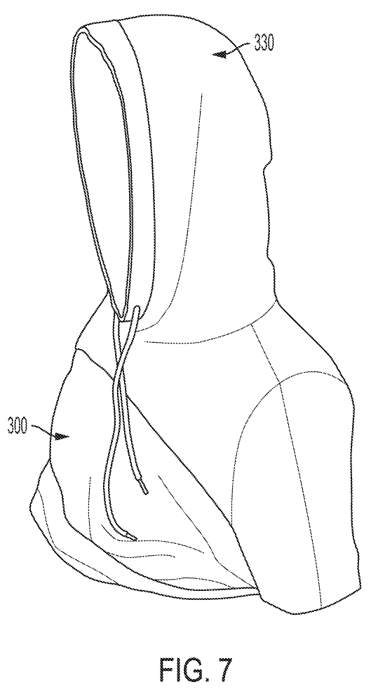

FIG. 6 and FIG. 7 show a mannequin attachment device 100 fitted upon the mannequin 200 in use with a garment 300 having a hood 330. FIG. 6 is a front view of a mannequin attachment device 100 in use with hooded garment 300, and FIG. 7 is a side perspective view of the same mannequin attachment device 100 in use with the same hooded garment 300. The lower portion of the garment 300 may rest upon the shoulder structure of the mannequin, thereby covering the lower portion of a mannequin attachment device. Where desired, the neck structure 220 of the mannequin 200 can be visible, such as is shown in FIG. 6. As explained in greater detail herein, the upper portion 130 of a mannequin attachment device 100 may stabilize, shape, and/or provide support for the hood 330 of the garment 300. In particular embodiments, the upper portion 130 of a mannequin attachment device 100 may stabilize and/or support the hood 330 of the garment 300 in such a way that that hood 330 may be shaped to resemble the shape of the hood 330 if worn by a real human being. Although numbered for clarity in FIG. 6, the various portions of a mannequin attachment device 100 (e.g., upper portion 130 and intermediate portion 120) may be substantially non-visible behind the garment 300. In this way, a mannequin attachment device 100 may provide a realistic and visually pleasing experience for one viewing the garment.

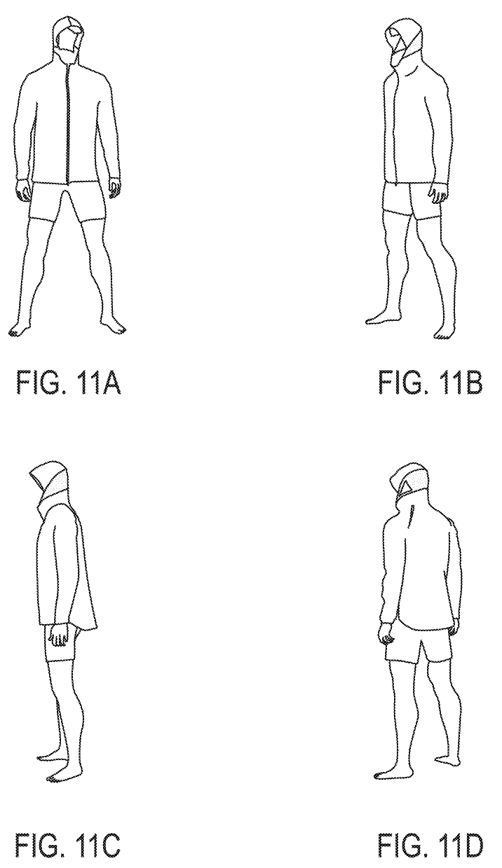

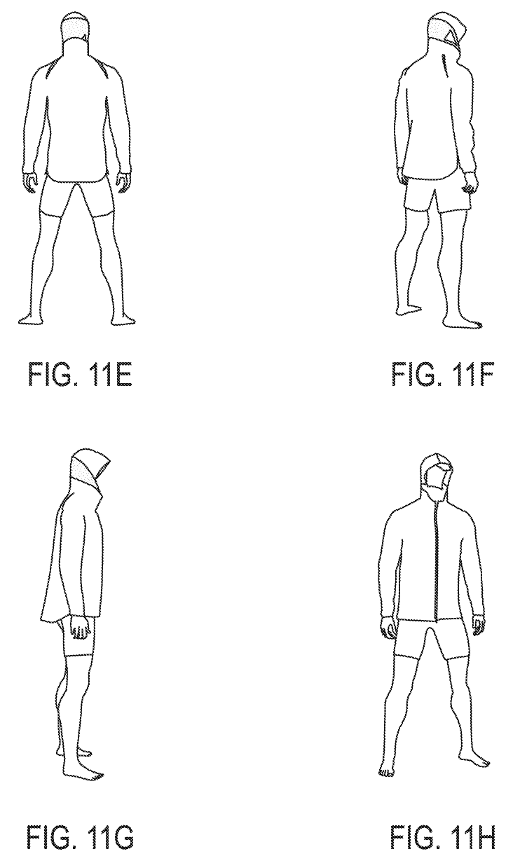

FIGS. 11A-11H show additional embodiments with a mannequin attachment device fitted upon a mannequin in use with a garment having a hood.

The preferred method for dressing a mannequin with a hooded garment using a mannequin attachment device is described with respect to FIG. 6. For example, to dress mannequin 200 with a garment 300 having a hood 330, a mannequin attachment device 100 may be fitted upon the mannequin 200 prior to being dressed with the hooded garment (refer to FIGS. 1-4). Once a mannequin attachment device 100 is fit upon the mannequin 200, the mannequin 200 may be dressed with the hooded garment 300 in the same way as a human would customarily put on the hooded garment. That is, the opening at the lower end of the hooded garment can be placed over the upper portion 130 of a mannequin attachment device 100 and pulled down over the lower portion 110 of a mannequin attachment device 100 and the shoulder structure 210 of the mannequin 200. In this way, the inner surface of the hood 330 of the garment 300 may be brought to rest in contact with the outer surface 139 of the upper portion 130 of a mannequin attachment device 100. In this way, the upper portion 130 of a mannequin attachment device 100 may support and/or stabilize the hood of the garment and give a realistic shape and appearance to the garment as if worn by a real human. As will be recognized by one of skill in the art, in an embodiment, a mannequin attachment device may be configured to support a hat rather than a hood.

The hood of the garment may be adjusted, as necessary, to cover substantially the entirety of the outer surface 139 of the upper portion 130 of a mannequin attachment device 100, thereby preventing or minimizing the visibility of the upper portion 130 of a mannequin attachment device 100 during use. Similarly, the body portion of the garment may cover the lower portion 110 of a mannequin attachment device 100, thereby preventing or minimizing the visibility of the lower portion 110 of a mannequin attachment device 100 during use. Finally, the intermediate portion 120 of a mannequin attachment device 100 may be covered along its outer surface by the lower portion of the hood of the garment, while the inner surface 128 of the intermediate portion 120 may be positioned behind the neck structure 220 of the mannequin 200, thereby preventing or minimizing the visibility of the intermediate portion 120 of a mannequin attachment device 100 during use. In summary, when in use with a mannequin dressed with a hooded garment, a mannequin attachment device 100 may be substantially invisible, or, at the very least, the visibility of a mannequin attachment device 100 may be significantly reduced.

As previously described, various portions of mannequin attachment devices and mannequins described herein may be shaped to at least partially simulate various structures of the human anatomy. In this way, the various portions of mannequin attachment devices and mannequins described herein can be sized to correspond to various structures of the human anatomy. For example, where the mannequin is sized so as to correspond to a normal-sized human child, a mannequin attachment device can be correspondingly sized so as to simulate the sizes of the shoulder, neck, and cranial structures of a normal-sized human child. As a result, a particular mannequin attachment device can be customized during design and manufacture to be used with a particular mannequin having specific dimensions and undulations or features.

As will be appreciated by those skilled in the art, mannequin attachment devices of the present disclosure can be made of any suitable material, such as cardboard, polyurethane, metal, plaster, plastic, recyclable paper, fiberglass, ceramic, and wood, any combination thereof, or any other material with sufficient strength and stiffness to withstand the forces upon it during use (i.e., sufficient to provide support, stabilization, and shape to a hooded garment or other headwear). In an embodiment, a mannequin attachment device may be made of polyurethane. In an embodiment, a mannequin attachment device may be made using a 3D printing or additive manufacturing process. The mannequin can be made of the same or different material, as desired.

The size and shape of a mannequin attachment device can also be designed and varied as desired, such as for use with mannequins of different sizes and shapes and headwear or hooded garments of different sizes and shapes. In certain embodiments, the amount of material required and resulting weight of a mannequin attachment devices may be advantageously kept at a minimum by constructing the upper portion of the device with a cobra-head shape that defines a hollow space between the concave inner surface of the upper portion and the lower portion and a hollow space between the concave inner surface of the upper portion and the neck structure of an associated mannequin. In particular, a mannequin attachment device can be constructed with a substantially constant thickness of between about 0.05 and about 0.5 inches. In embodiments, a mannequin attachment device may be a rigid, solid device with no hollow interior between the inner and outer surfaces thereof.

Some exemplary additive manufacturing processes for making the mannequin attachment devices may include stereolithography, laser sintering, fused deposition modeling, 3D printing, multi-jet fusion, rapid prototyping, injection molding, and the like.

Stereolithography is a laser-based technology that may use an ultraviolet-curable material (e.g., an ultraviolet-sensitive liquid resin, such as a photopolymer resin). An ultraviolet laser beam can be used to scan the surface of the material and selectively harden the material corresponding to a cross-section of the product. More particularly, a computer-aided-design program can be used with an ultraviolet laser to draw a pre-designed shape on to the surface of the photopolymer resin. Because photopolymers are sensitive to ultraviolet light, the resin may photochemically solidify and form a single layer of the desired 3D product (i.e., by focusing the beam onto the surface of the liquid photopolymer, each layer of the desired 3D product may be created by means of crosslinking). The process can then be repeated for each layer of the design until the 3D product is complete. Stereolithography may be useful for products with complex geometries or other fine details (e.g., mannequin attachment devices with various specific undulations) and may further be useful for providing parts with smooth finishes.

Laser sintering is also a laser-based technology. Laser sintering may use a solid powder material (e.g., plastics, metal powder, various metal powders that may alloy when fused, etc.) successively spread on top of one another. A laser beam can be used to selectively bind together particles in the powder bed by raising the powder temperature above the glass transition point and/or the melting point, after which adjacent particles flow together. Laser sintering may be useful for customized products that are produced in limited quantities (e.g., a mannequin attachment device designed for use with a specific mannequin). Where desired, metallic powders can be deposited to provide for a metal or alloyed product. Examples may include selective laser sintering, selective laser melting, direct metal laser sintering, and the like.

Fused deposition modeling is a filament-based technology that may employ a thermoplastic modeling filament. The thermoplastic modeling filament can be heated to a semi-liquid state and then deposited in successive layers to build a product. Fused deposition modeling may be useful for products where durability and stability is a desired.

Multi-jet fusion is a powder-based technology that does not use layers. Rather, the powder bed may be heated uniformly, and a fusing agent and a detailing agent can be jetted to selectively melt powder particles and improve resolution. Lamps can also be employed to pass over the surface constantly. The jetted material may thereby capture and distribute the heat through the entirety of the part. Multi jet fusion may be useful for complex end-use parts.

Disclosed in exemplary embodiments herein is a method of manufacturing a mannequin attachment device using additive manufacturing, such as a 3D-printing process. A topographical scan of a mannequin can be taken to obtain data, such as the dimensions of the neck and shoulder structures of the mannequin. In particular, the topographical scan can provide data including three-dimensional reference points of the outer surface of the mannequin, including any curves, undulations, or other features that are a part of the mannequin.

A virtual image of the mannequin can be created from the data obtained from the topographical scan. The virtual image can be created, for example, using a computer-aided-design program. The virtual image of the mannequin can be created using the obtained three-dimensional reference points from the topographical scan. In particular, the obtained three-dimensional reference points may provide an outer boundary (i.e., along the outer surface) for one or more portions of the mannequin (e.g., the head and shoulder structures of the mannequin, if provided).

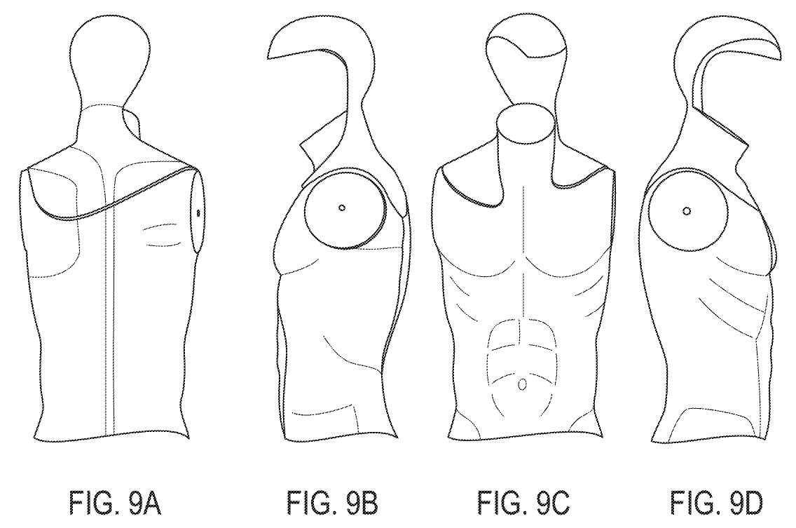

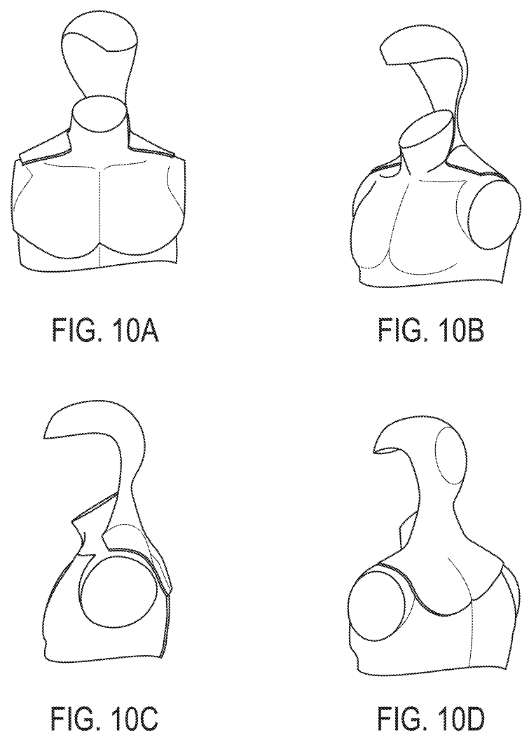

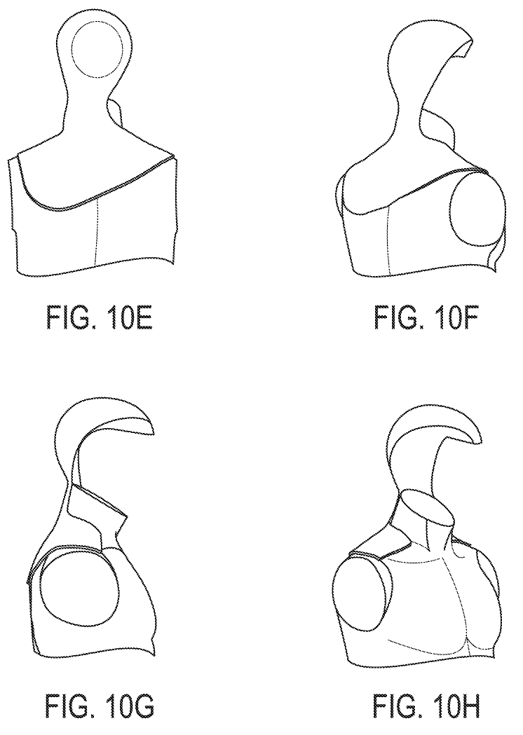

Next, a virtual image of a mannequin attachment device can be created. Like the virtual image of the mannequin, the virtual image of the mannequin attachment device can be created using a computer-aided-design program. In particular, the virtual image of the mannequin attachment device can be created by plotting three-dimensional definition points corresponding to an inner surface of the mannequin attachment device. In this way, the definition points may provide an inner boundary (i.e., along the inner surface) for one or more portions of the mannequin attachment device (e.g., the lower and intermediate portions, if provided). To help ensure that the mannequin attachment device may be operatively connectable to the mannequin in a substantially exact fit therewith, the definition points of the inner surface of the mannequin attachment device can be spaced outwardly apart a selected distance from corresponding ones of the reference points of the outer surface of the mannequin. Put another way, the inner surface of the mannequin attachment device can be designed (e.g., in a computer-aided-design program) to fit contiguously in a substantially exact engagement with an outer surface of at least a portion of the mannequin (refer to FIGS. 9A-9D, which show a mannequin attachment device in snug and substantially exact engagement with a mannequin).

The mannequin attachment device can then be manufactured from its virtual image by an additive manufacturing process. In particular, layers of a material (e.g., a polymeric material, a powder material, a resin material, a filament material, or a combination thereof) can be deposited over a confined region defined by the virtual image of the mannequin attachment device. The layers may be deposited such that each layer is substantially even (i.e., the same depth as the other layers). A laser can be used to bind the material in each layer before depositing a successive layer. The layers can be successively deposited a selected number of times until the mannequin attachment device is fully constructed.

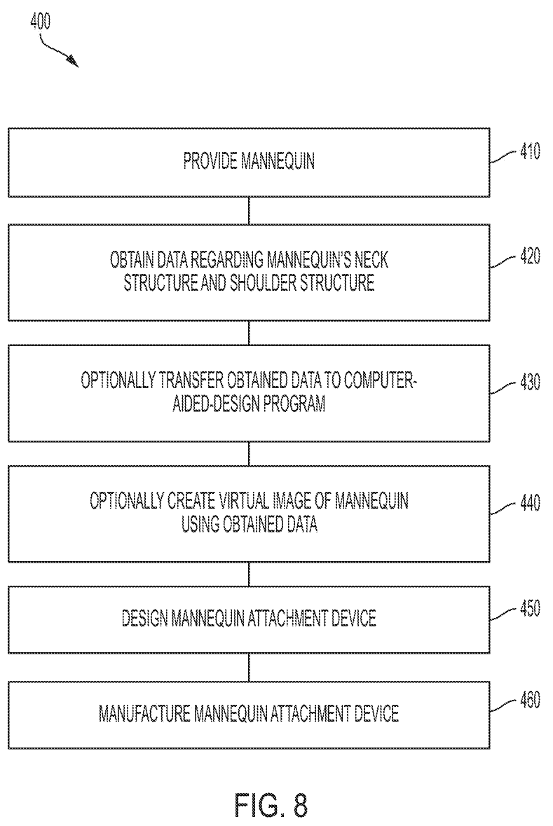

Turning to FIG. 8, an example method of manufacturing a mannequin attachment device is also provided. The method 400 may begin with step 410 of providing a mannequin having at least a neck structure and a shoulder structure, such as mannequin 200 depicted in FIGS. 1-4. In this regard, the mannequin provided in step 410 could be an existing mannequin or, alternatively, could be a mannequin that is designed for use with a specific mannequin attachment device.

Next, step 420 of obtaining data regarding the mannequin's neck structure and shoulder structure may be performed. The data obtained in step 420 may be the dimensions of the neck and shoulder structures of the mannequin and can include data regarding any curves, undulations, or other features that are a part thereof. In embodiments, step 420 can be performed, for example, by taking a topographical scan of the neck and shoulder structures of the mannequin, manually measuring the neck and shoulder structures of the mannequin, stereoscopically photographing the neck and shoulder structures of the mannequin, creating a mold of the mannequin, test-fitting various devices to the mannequin, scanning the mannequin (e.g., with a laser scanner, infrared scanner, or the like), or any other suitable method for determining the dimensions or other characteristics of the mannequin that may aid in the design of a mannequin attachment device that operatively fits upon the mannequin.

Before designing a mannequin attachment device, one or more optional steps may be performed. For example, a step 430 can be performed in which the data obtained regarding the mannequin's neck and shoulder structures may be transferred to a computer-aided-design (CAD) program. The CAD program can be used, for example, to perform a step 440 of creating a virtual image (e.g., a three-dimensional rendering or model) of the neck and shoulder structures of the mannequin using the obtained data. The same or a different CAD program can also be used in step 450 to design a mannequin attachment device. For example, the CAD program can be used to fit a rendering of a mannequin attachment device and a rendering of the associated mannequin together to ensure that the designed mannequin attachment device may operatively connect with the mannequin. In an embodiment, the CAD program can be used to fit a rendering of a mannequin attachment device and a rendering of the associated mannequin together to ensure that the designed mannequin attachment device may operatively connect snugly or substantially exactly with the mannequin (refer to FIGS. 9A-9D, which show a mannequin attachment device in snug and substantially exact engagement with a mannequin).

After obtaining the data in step 420 or after performing one more of optional steps 430 and 440, step 450 of designing a mannequin attachment device may be performed. A mannequin attachment device can be designed, for example, as described above with respect to mannequin attachment device 100 or can be designed with more or less features that enable the device to fit cooperatively upon the corresponding mannequin. A mannequin attachment device may be preferably designed with an overall shape that is complementary to the shape of the mannequin, including any contours, undulations, or other features thereof. In embodiments, the design of the mannequin attachment device may be customized so as to fit an existing mannequin having a specific size and shape. A mannequin attachment device designed in step 450 may be preferably designed to be rigid and operatively connect with or abut the mannequin, for example, without the use of a mechanical attachment mechanism.

Finally, a step 460 of manufacturing a mannequin attachment device may be performed. The manufacturing of a mannequin attachment device can be achieved by any suitable process, such as three-dimensional printing, blow molding, injection molding, rotational molding, and/or casting. In an embodiment, a mannequin attachment device according to the present disclosure may be manufactured as a unitary piece and may be free from welds, seams, adhesives, and/or mechanical fasteners.

A mannequin attachment device can then be fit to the mannequin in the manner previously described, thereby creating a hooded garment or other headwear display system, such as system 10 depicted in FIGS. 1-4.

In alternate embodiments, other devices may be produced using one or more of the previously described additive manufacturing processes. Devices so made may have unitary structures, absent from welds or fasteners holding the device together. In an embodiment, an alternate device may be a mannequin attachment device designed to have an outline or three-dimensional shape of a human body part, such as a human hand. In an embodiment, such a mannequin attachment device designed as a human hand may be manufactured as a unitary piece and have a lattice, mesh, or other open-framework structure. Such an embodiment may present an advantageous aesthetic appeal and may advantageously weigh less, such that manipulation of the mannequin attachment device and/or a mannequin on which the mannequin attachment device is affixed is easier to maneuver or re-position. One of skill in the art will appreciate that devices resembling other human appendages and body parts may be similarly created. In an embodiment, a mannequin sized and shaped as a complete, fully grown, adult human may be manufactured in a similar manner.

In an embodiment, an example process for creating a mannequin attachment device designed to resemble a human hand using an additive manufacturing process is described. A hand (e.g., an existing solid mannequin hand or a human hand) may be posed using design software or a three-dimensional or topographical scan to generate a digital file containing data modeling the hand. The digital file may be cleaned or standardized, and the digital file may be altered to incorporate a pattern such as a lattice, mesh, or open framework structure. In an alternate embodiment, the hand may retain a solid outline to resemble a traditional (e.g., solid or molded) mannequin hand. Any such pattern may be a standard pattern or a custom-designed pattern. In an embodiment, a concession may be made to the digital file to allow hardware to be added after the mannequin attachment device is created. Such hardware may, for example, allow the mannequin attachment device (e.g., resembling a hand) to be attached to a mannequin.

As used herein, a device may have a unitary structure if the device itself is constructed as one piece. Such a device may still be considered unitary if it includes hardware (e.g., to attach the device to another component, such as a hand to an arm), as long as the device itself is constructed as a single piece. As an alternative to hardware, in an embodiment, a device may be additively manufactured with integrated attachment features, such as threads or snap-fit engagements.

Other devices (which may or may not be a mannequin attachment device) may be created using additive manufacturing processes. For example, accessories for displaying retail products (but are not human-shaped) may be created. In an embodiment, a basketball created with a mesh, lattice, or open-framework pattern may be created as a unitary structure using an additive manufacturing process. In an alternate embodiment, a basketball structure so manufactured may be designed to incorporate shelving (e.g., in a cutout of the substantially spherical basketball shape) to hold a retail item such as basketball shoes.

The foregoing description of specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It will be appreciated by those of ordinary skill in the art that the components, method steps and materials illustrated above may be varied by substitution of equivalent components, steps and materials capable of performing the same functions. It will also be appreciated by one of ordinary skill in the art that sizes and strengths of the components can be scaled up or down as required for specific purposes. The claims hereof are intended to encompass all such equivalent components, method steps and scales.

What is claimed is:

1. A mannequin attachment device, comprising:
a lower portion sized and shaped to remain in a substantially fixed position when placed on an associated mannequin, the lower portion including first and second side segments extending outwardly in opposing directions from a central segment thereof;
a substantially hemispherical upper portion; and
an intermediate portion extending between and interconnecting the lower portion and the upper portion.

2. The mannequin attachment device of claim 1, wherein:
the lower portion is shaped so as to at least partially simulate the shoulder structure of the associated mannequin; and
the upper portion is shaped so as to at least partially simulate a cranial structure of the human anatomy.

3. The mannequin attachment device of claim 1, wherein the first and second side segments are each bowed from a front edge to a rear edge thereof.

4. The mannequin attachment device of claim 1, wherein the upper portion is substantially centered between the first and second side segments and above the central segment.

5. The mannequin device of claim 1, wherein the upper portion has a concave inner surface and a convex outer surface.

6. The mannequin attachment device of claim 1, wherein the mannequin attachment device is constructed from a material selected from the group consisting of cardboard, polyurethane, metal, plaster, plastic, recyclable paper, fiberglass, ceramic, and wood.

7. The mannequin attachment device of claim 1, wherein the mannequin attachment device has a substantially constant thickness of between about 0.05 and about 0.5 inches.

8. The mannequin attachment device of claim 1, wherein the lower portion, the substantially hemispherical upper portion, and the intermediate portion are formed as a unitary piece.

9. A system, comprising:
a mannequin having a shoulder structure and a neck structure protruding upwardly from the shoulder structure; and
a mannequin attachment device including:
a lower portion sized and shaped to hold the device in a substantially fixed position when placed on the mannequin, the lower portion including first and second side segments extending outwardly in opposing directions from a central segment thereof;
a substantially hemispherical upper portion; and
an intermediate portion extending between and interconnecting the lower portion and the upper portion; and
wherein the mannequin attachment device is devoid of a mechanical attachment to the mannequin.

10. The system of claim 9, wherein:
the intermediate portion of the mannequin attachment device is shaped complementary to the neck structure of the mannequin and an inner surface of the intermediate portion is sized and shaped for selective abutment against the neck structure of the mannequin;
the lower portion of the mannequin attachment device is shaped complementary to the shoulder structure of the mannequin and an inner surface of the lower portion is sized and shaped for selective abutment against the shoulder structure of the mannequin; and
the shoulder structure of the mannequin includes one or more undulations and the first and second side segments and the central segment are each sized and shaped for selective abutment against the one or more undulations of the shoulder structure of the mannequin.

11. The system of claim 9, wherein the substantially hemispherical upper portion of the mannequin attachment device does not abut any part of the mannequin.

12. The system of claim 9, wherein the lower portion, the intermediate portion, and the substantially hemispherical upper portion of the mannequin attachment device are formed as a unitary piece.

13. The system of claim 12, wherein the mannequin attachment device is substantially non-visible.

14. A method of manufacturing a mannequin attachment device, the method comprising:
obtaining data from a topographical scan of a mannequin;
creating a virtual image of a mannequin attachment device;
successively distributing a selected number of substantially even layers of a material over a confined region defined by the virtual image of the mannequin attachment device; and
binding the material in each successive layer until the mannequin attachment device is fully constructed.

15. The method of claim 14, wherein:
the material is selected from the group consisting of a polymeric material, a powder material, a resin material, a filament material, and combinations thereof; and
the mannequin attachment device is manufactured by a process selected from the group consisting of three-dimensional printing, blow molding, injection molding, rotational molding, and casting.

16. The method of claim 14, wherein obtaining data from the topographical scan of the mannequin includes obtaining three-dimensional reference points of an outer surface of the mannequin.

17. The method of claim 16, wherein creating the virtual image of the mannequin attachment device includes plotting three-dimensional definition points corresponding to an inner surface of the mannequin attachment device, the definition points of the inner surface of the mannequin attachment device being spaced outwardly apart a selected distance from corresponding ones of the reference points of the outer surface of the mannequin, such that the mannequin attachment device is operatively connectable to fit substantially exactly upon the mannequin.

18. The method of claim 17, further comprising transferring the obtained data to a computer-aided-design program and creating a virtual image of the mannequin prior to creating the virtual image of the mannequin attachment device.

19. The method of claim 14, wherein the mannequin has a shoulder structure and a neck structure protruding upwardly from the shoulder structure, and wherein the obtained data includes data regarding the mannequin's shoulder structure and neck structure.

20. The method of claim 14, wherein the mannequin attachment device, when fully constructed, includes:
a lower portion shaped complementary to the mannequin's shoulder structure and sized and shaped to hold the mannequin attachment device in a substantially fixed position upon the mannequin, the lower portion including first and second side segments extending outwardly in opposing directions from a central segment thereof;
a substantially hemispherical upper portion; and
an intermediate portion shaped complementary to the mannequin's neck structure and extending between and interconnecting the lower portion and the upper portion.

21. The method of claim 20, wherein the mannequin attachment device, when fully constructed, is a unitary piece.
